(19) United States
(12) Patent Application Publication
(10) Pub. No.: US 2021/0124116 A1
(43) Pub. Date: Apr. 29, 2021

(54) METHODS OF DESIGNING AND MANUFACTURING OPTIMIZED OPTICAL WAVEGUIDES

(71) Applicant: University of Central Florida Research Foundation, Inc., Orlando, FL (US)

(72) Inventors: James Joseph Inziello, Orlando, FL (US); Fluvio Lobo Fenoglietto, Orlando, FL (US); Jack Stubbs, Orlando, FL (US)

(21) Appl. No.: 17/078,795

(22) Filed: Oct. 23, 2020

Related U.S. Application Data
(60) Provisional application No. 62/925,004, filed on Oct. 23, 2019.

(51) Int. Cl. G02B 6/12; G02B 6/13; G02B 27/00; G01L 1/24

(52) U.S. Cl. CPC G02B 6/12004; G02B 6/13; G02B 2006/12138; G01L 1/24; G02B 27/0012

(57) ABSTRACT

Methods of optimizing additive manufactured three dimensional structures that are designed to output a desired set of optical properties, particularly for use in tactile-based sensing applications. The optical properties within an object are highly-customizable and can be altered on a voxel-by-voxel level, such that the resulting optical properties can be used in applications in which discreet points within the object are interactable in different ways, thereby providing for different sensations depending on the selected discreet point. Moreover, the selected optical properties can differ between adjacent voxels, allowing for precise customization of the object depending on the requirements of the manufactured object. As a result, the resulting three dimensional structures include a precise, desired set of optical properties, providing for intricate interactions by a user in tactile applications.

### CROSS-REFERENCE TO RELATED APPLICATIONS

This nonprovisional application is a continuation of and claim priority to provisional application No. 62/925,004, entitled “Methods of designing and manufacturing optimized optical waveguides,” filed on Oct. 23, 2019, by the same inventors.

### BACKGROUND OF THE INVENTION

### 1. Field of the Invention

This invention relates, generally, to methods and apparatuses designed to improve the optical properties of a 3D printed object. More specifically, it relates to methods of optimizing and printing optical waveguides on a voxel-by-voxel level to improve the optical properties and accuracy of an additive manufactured object.

### 2. Brief Description of the Prior Art

While an important goal of additive manufacturing is to generate objects with accurate geometries, equally important is the requirement that additive manufactured objects have a set of desired properties to behave in particular ways to physical stimuli. The selection and optimization of such properties is challenging in many printing projects, not only because there are many different properties to consider (i.e., physical, electrical, thermodynamic, optical, etc.), but also because customization of these properties across an object is difficult to achieve. In typical additive manufacturing projects, entire components are printed with a near-uniform set of materials having set properties; in a complex project with multiple components, the printed objects are later assembled into a singular object. However, such typical processes do not account for differences in properties between discreet points on one of the components, leading to manufactured objects that do not accurately represent the desired properties in a uniform manner.

Specifically regarding optical properties, important considerations are the amount and direction that light is directed or transmitted at a boundary surface. According to Snell's law, the ratio of the sines of the angles of incidence and of refraction is equal to the ratio of the phase velocities in the two media, as well as the ratio of the indices of refraction, as outlined in Equation 1 below:

sin θ₂/sin θ₁=v₂/v₁=n₁/n₂ (1)

with θ₂ being the angle of incidence, θ₁ being the angle of refraction, v₂ being the velocity in the secondary medium, v₁ being the velocity in the initial medium, n₂ being the index of refraction for the secondary medium, and n₁ being the index of refraction for the initial medium. Each angle is measured from the normal of the boundary, as the velocity of light in the respective medium, the wavelength of light in the respective medium, and the refractive index in the respective medium. These angles are shown in FIGS. 1A-1B, showing the degree of specular and scatter effects that the boundary has on incident light waves; FIGS. 1C-1D, showing the absorption, reflection, and transmission of light through a medium; and FIG. 1E, showing the degree of refraction as a result of the volume. In addition, as shown in FIG. 1F, a boundary can change the state of light polarization, resulting in different optical properties.

Returning to additive manufacturing applications, it is typically challenging to accurately represent the optical properties and effects discussed above, particularly if the material used in the additive manufacturing process is inaccurately uniform. Accordingly, what is needed is an in-depth, highly customizable method of selecting and optimizing optical properties on a voxel level to select different desired materials based on optical properties and to determine boundary conditions between discreet points of the 3D object. However, in view of the art considered as a whole at the time the present invention was made, it was not obvious to those of ordinary skill in the field of this invention how the shortcomings of the prior art could be overcome.

All referenced publications are incorporated herein by reference in their entirety. Furthermore, where a definition or use of a term in a reference, which is incorporated by reference herein, is inconsistent or contrary to the definition of that term provided herein, the definition of that term provided herein applies and the definition of that term in the reference does not apply.

While certain aspects of conventional technologies have been discussed to facilitate disclosure of the invention, Applicant in no way disclaims these technical aspects, and it is contemplated that the claimed invention may encompass one or more of the conventional technical aspects discussed herein.

The present invention may address one or more of the problems and deficiencies of the prior art discussed above. However, it is contemplated that the invention may prove useful in addressing other problems and deficiencies in a number of technical areas. Therefore, the claimed invention should not necessarily be construed as limited to addressing any of the particular problems or deficiencies discussed herein.

In this specification, where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

### BRIEF SUMMARY OF THE INVENTION

The long-standing but heretofore unfulfilled need for additive manufactured objects having customizable sets of optical properties is now met by a new, useful, and nonobvious invention.

The novel optical waveguide assembly includes an optical waveguide disposed within a tactile additive manufactured object. The optical waveguide is made of a transparent material having a first refractive index and includes a first end opposite a second end, such that the optical waveguide is configured to direct light from the first end to the second end. A sheath surrounds the optical waveguide, with the sheath having a second refractive index that differs from the first refractive index, such that the optical waveguide is configured to experience total internal reflection of the light, and such that the optical waveguide is configured to prevent the light from escaping into the sheath. A support medium is secured to the sheath and is configured to maintain a structure of the sheath during an additive manufacturing process. An additive manufactured object having a predetermined shape and size is printed to surround the sheath, such that the optical waveguide and the sheath are disposed within the additive manufactured object within the optical waveguide assembly.

In an embodiment, the optical waveguide exhibits anisotropic optical properties. The anisotropic optical properties are selected from the group consisting of opaqueness, reflectiveness, colorization, transparency, transmission, absorption, refractive indices, attenuation, phase change, polarization, and stress birefringence.

An embodiment of the optical waveguide includes a plurality of discreet points that correspond with a plurality of voxels of a virtual representation of the optical waveguide. Each of the plurality of discreet points includes a customizable base material, such that optical properties of the optical waveguide are tunable for each of the plurality of discreet points. A plurality of boundary layers may be disposed between adjacent discreet points of the plurality of discreet points. In an embodiment, each of the plurality of boundary layers is discreet and wavelength-dependent.

An embodiment of the optical waveguide includes a single-channel waveguide configured to direct light from the first end to the second end. Alternative embodiments of the optical waveguide include a plurality of channels, such that the optical waveguide is configured to direct light from the first end to the second end through each of the plurality of channels. In an embodiment, at least one of the plurality of channels of the optical waveguide includes a volume that differs from a volume of the remaining plurality of channels. An embodiment of the optical waveguide is flexible and non-linear, such that the optical waveguide is configured to direct light from the first end to the second end in a non-linear path.

The novel method is directed to designing and manufacturing integrated optical components in an additive manufactured composite structure for the purpose of physical sensing of forces applied to the structure. The method includes a step of designing a virtual model of the additive manufactured composite structure. The virtual model is comprised of a plurality of voxels. The additive manufactured composite structure includes a desired set of anisotropic optical properties, with each of the plurality of voxels being individually tunable by varying one or more optical properties.

An additive manufactured composite structure is manufactured that is based on the virtual model. The additive manufactured composite structure includes an optical waveguide, a sheath surrounding the optical waveguide, and a support medium secured to the sheath. The optical waveguide has a first refractive index and includes a first end opposite a second end, such that the optical waveguide is configured to direct light from the first end to the second end. A sheath surrounds the optical waveguide, with the sheath having a second refractive index that differs from the first refractive index, such that the optical waveguide is configured to experience total internal reflection of the light, and such that the optical waveguide is configured to prevent the light from escaping into the sheath. A support medium is secured to the sheath and is configured to maintain a structure of the sheath during an additive manufacturing process.

The method includes a step of directing light through the optical waveguide of the additive manufactured composite structure, such that physical sensing of forces applied to the structure can be accomplished by interacting with the light directed through the optical waveguide. In an embodiment in which the optical waveguide includes a plurality of channels, at least one of the plurality of channels may includes a volume that differs from a volume of the remaining plurality of channels. In such an embodiment, the step of directing light through the optical waveguide includes directing a different amount of light through at least one of the plurality of channels as compared with the remaining plurality of channels.

An object of the invention is to create objects capable for use in tactile applications based on a highly-customizable, optimized set of optical properties, such that light appears different within the objects depending on the selected optical properties.

These and other important objects, advantages, and features of the invention will become clear as this disclosure proceeds.

The invention accordingly comprises the features of construction, combination of elements, and arrangement of parts that will be exemplified in the disclosure set forth hereinafter and the scope of the invention will be indicated in the claims.

### BRIEF DESCRIPTION OF THE DRAWINGS

For a fuller understanding of the invention, reference should be made to the following detailed description, taken in connection with the accompanying drawings, in which:

FIG. 1A depicts the specular and scatter effects that a boundary has on incident light.

FIG. 1B shows the specular and scatter effects that a boundary has on incident light.

FIG. 1C shows the absorption effects of a medium on propagating light.

FIG. 1D shows the reflection, absorption, and transmission of light in a given medium.

FIG. 1E depicts the refraction of light within a volume.

FIG. 1F depicts the effect of a polarizing filter on incident light, specifically showing the change in polarization state as a result of a boundary.

FIG. 2A is a depiction of equally-sized and shaped voxels having uniform properties within a volume.

FIG. 2B shows the volume of FIG. 2A with voxels have different properties.

FIG. 2C shows the volume of FIG. 2B with an alteration in the optical property of transparency for each of the voxels within the volume.

FIG. 3 is a perspective view of an example of an additive manufactured optical waveguide, in accordance with an embodiment of the present invention.

FIG. 4A is a perspective view of a single channel waveguide within a medium.

FIG. 4B is a perspective view of a three-channel waveguide within a medium.

FIG. 4C is a perspective view of a two-channel, bifurcated waveguide within a medium, with the two channels having different optical properties.

FIG. 4D is a perspective view of a three-channel, trifurcated waveguide within a medium, with the three channels having similar optical properties.

FIG. 4E is a perspective view of a three-channel, trifurcated waveguide within a medium, with the three channels having different optical properties, specifically different color illuminations within the channels.

FIG. 5A is a perspective view of a sensing waveguide array, in accordance with an embodiment of the present invention.

FIG. 5B is a perspective view of the sensing waveguide array of FIG. 5A, showing the throughput of light through the array.

FIG. 5C is a perspective view of the sensing waveguide array of FIG. 5A, showing selective light throughput of a single color.

FIG. 5D is a perspective view of the sensing waveguide array of FIG. 5A, showing light throughput within each channel of different colors.

FIG. 6 depicts a system including a light source, a waveguide in accordance with embodiments of the present invention, and a sensor or camera component to capture the light propagated through the waveguide.

FIG. 7A is an elevation view of a focusing apparatus used in combination with a waveguide to direct light propagation in a desired manner.

FIG. 7B is an elevation view of a focusing apparatus used in combination with a waveguide to direct light propagation in a desired manner.

FIG. 7C is a perspective view of a focusing apparatus having different layers of variable refractive indexes used in combination with a waveguide to direct light propagation in a desired manner.

FIG. 8A depicts an additive manufactured single element waveguide showing light throughput through the waveguide.

FIG. 8B depicts the waveguide of FIG. 8A showing light obstructed therethrough.

FIG. 8C depicts the waveguide of FIG. 8A within a support medium.

FIG. 9A depicts a plurality of transparent and colored additive manufactured waveguides, in accordance with an embodiment of the present invention.

FIG. 9B depicts the waveguides of FIG. 9A within a support medium.

FIG. 9C depicts a single transparent trifurcated waveguide, similar to the structure of the waveguide depicted in FIG. 4D, within a support medium.

FIG. 10 depicts various additive manufactured optical waveguides. in accordance with embodiments of the present invention.

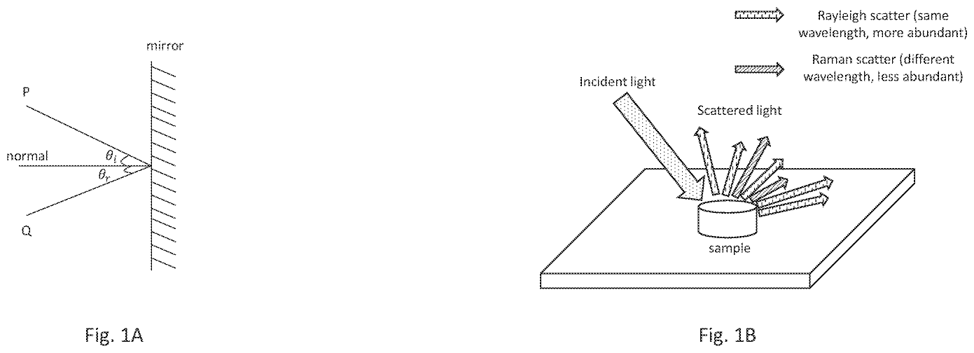

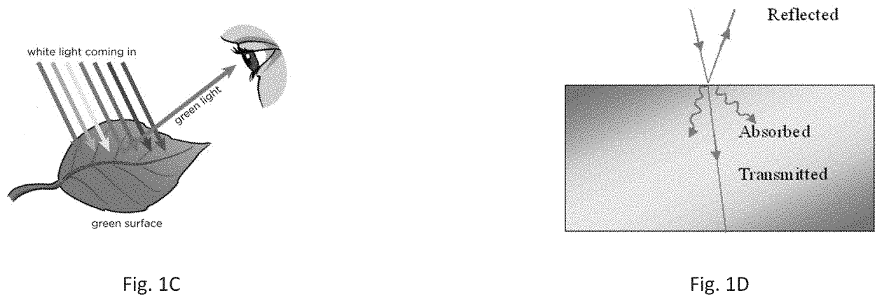

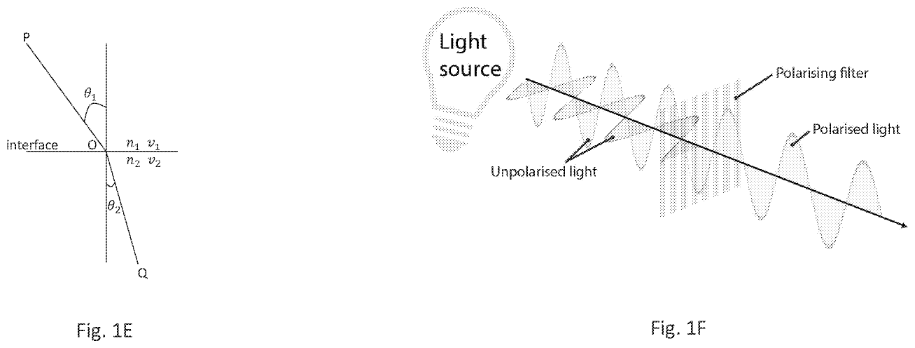

### DETAILED DESCRIPTION OF THE INVENTION

In the following detailed description of the preferred embodiments, reference is made to the accompanying drawings, which form a part thereof, and within which are shown by way of illustration specific embodiments by which the invention may be practiced. It is to be understood that other embodiments may be utilized and structural changes may be made without departing from the scope of the invention.

As used in this specification and the appended claims, the singular forms “a,” “an,” and “the” include plural referents unless the content clearly dictates otherwise. As used in this specification and the appended claims, the term “or” is generally employed in its sense including “and/or” unless the context clearly dictates otherwise.

The present invention includes additive manufactured three dimensional structures that are designed to output a desired set of optical properties, particularly for use in tactile-based sensing applications. By altering the optical properties within an object, particularly on a voxel-by-voxel level, the resulting optical properties can be used in applications in which discreet points within the object are interactable in different ways, providing for different sensations based on visual light depending on the selected discreet point. Moreover, the selected optical properties can differ between adjacent voxels, allowing for precise customization of the object depending on the requirements of the manufactured object. As a result, the resulting three dimensional structures include a precise, desired set of optical properties, providing for intricate interactions by a user in tactile applications.

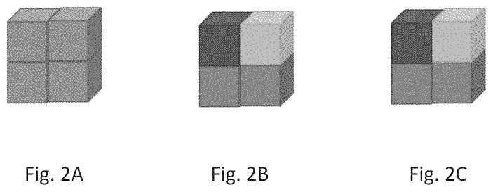

A voxel is a volumetric object that is used to define properties, sizes, and shapes of a three-dimensional object printed via additive manufacturing. Most voxels are three-dimensional; however, voxels can be one-dimensional or two-dimensional if certain dimensions are reduced to zero. In addition, voxels can be described by any shape and size, such are hexagonal, rectangular, circular, amorphous, and other geometric shapes. However, as shown in FIGS. 2A-2C, a typical representation is a cubic voxel for the simplicity of cartesian coordinate-based printers.

Current additive manufacturing printers can select materials based on desired properties, such as optical properties, but at limited to larger-scale selections than under the present method, which provides for voxel-level customization and printing. These optical properties include opaqueness, reflectiveness, colorization, transparency, transmission, absorption, refractive indices, attenuation, phase change, polarization, stress birefringence, and other optical properties, including combinations thereof. In current printers, voxels can be as small as 10 microns, with future technologies likely reducing these voxel sizes to the wavelength of visible light (i.e., 0.4 to 1 micron). Accordingly, customization at such a voxel level not only provides advantages in present day implementations, but the implications of ever-decreasing voxel sizes further illustrates the variation of optical properties within a singular composite object.

As shown in FIGS. 2A-2C, a simple cubic voxel-based volumetric can include a plurality of discreet points; in the case of the figures, there are four voxels depicted, each of which can be made of a different material or exhibit a different property, as shown in FIG. 2B. FIG. 2C depicts various optical properties being altered in one or more of the plurality of voxels, specifically the transparency of the voxels. The design and the pattern of the voxels in a composite object are used to control the additive effect in each voxel and, more specifically, in each axis of each voxel independently. For example, the absorption of light can be controlled by determining the optical density of individual voxels in a discreet area, such that selective light absorption can be accomplished, with the effect being spread throughout multiple voxels. The amount of absorption is controllable in each axis of propagation throughout the composite unit, leading to different tunable voxels for accomplishing a desired effect. Moreover, empty or void voxels can be used, which are filled with fluids or other media, such as air or gas, such that voxel is not printed during the manufacture of the object. The result is the creation of highly tunable voxels within a three-dimensional object, such that neighboring voxels can drastically differ in optical properties, leading to anisotropic optical properties to accurately represent a desired set of properties. It is appreciated that these methods can be used to manufacture objects such as fiber optic arrays with end curvatures to induce collection efficiencies, different colored fibers, sheaths for fibers to effect transmission properties, flexible and rigid elements within the same structure, and other objects and properties.

Furthermore, by characterizing the base materials that comprise each of the voxels, a controlled concentration of each of the materials can be determined for the desired optical properties and for the propagation of light through the boundaries of the media of the printed object. As such, boundary layers are defined that can be discreet, wavelength-dependent, and create a gradient in cases in which boundary layers are defined as being larger than a single voxel size. These boundaries and gradients can be used to accomplish various optical effects and properties within the printed object, such that light travels and bends in a desired pattern and trajectory. For example, refractive index lenses can be manufactured integrated into the additive manufactured object to effectively bend light for the lens effects of focusing and divergence, without the need for the lens to be a curved surface—instead, a planar surface can be used while accomplishing the same light bending as desired for the lenses.

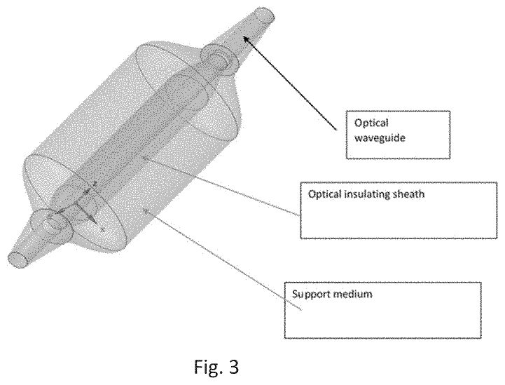

In addition, 3D-printed optical waveguides and waveguide arrays can be manufactured for the purposes of position tracking, force sensing, and modification of optical properties. These optical waveguides can be used for tactile sensing applications, with the guides being used to produce optical throughput in both rigid and flexible materials that are used to conduct light and to detect and register tactile applications such as touch, pressure, and location of light. An example of such a waveguide is shown in FIG. 3.

In particular, sensing via optical waveguide integration can occur in at least three areas of optical characteristics: attenuation, polarization, and signal phase change. Attenuation of light though a waveguide is produced from a change in the “impurities” within the optic. When known small particles of size shape and spacing are printed into the volume of a waveguide, the attenuation of light due to scattering and blockage can be modified in a calibrated way. In addition, polarization effects due to stress change the amount and polarized effect of the light propagating through the waveguide. Signal phase change can demonstrate the effects of stimulus to the waveguide by producing phase relationships of perturbation of modulated signals.

### Examples

Typically optical engineers work towards reducing the effects of stress and load on optical components because they cause reduced efficiency in transmission of light through the fiber or waveguide. This effect of measuring the change in waveguide throughput is used to deduce the amount of load or stress that the waveguide is presented. Each effect of polarization, though put, and scattering can be calibrated and characterized to calculate the effects of load on the construct including the waveguide.

Sensing applications in accordance with the waveguide can be accomplished in three axes and as touch, pressure, proximity, location, and presence. The waveguides allow light to travel from one end to the other end, through the object, acting similarly to a fiber optic cable or other conventional waveguide. In a preferred embodiment, the waveguide is made of a transparent material and is surrounded by a sheath of material with a different refractive index. As a result of the difference in refractive index. total internal reflection occurs within the waveguide, directing the light to travel through the waveguide itself without escaping from the guide, in a straight or a curved path across two or three dimensions. FIG. 3 also shows a support medium surrounding the sheath during the printing process, as well as an insulating shield disposed around the waveguide. The waveguide and the support medium can be flexible, such that the waveguide can be fitted or contoured to a body or a fixture.

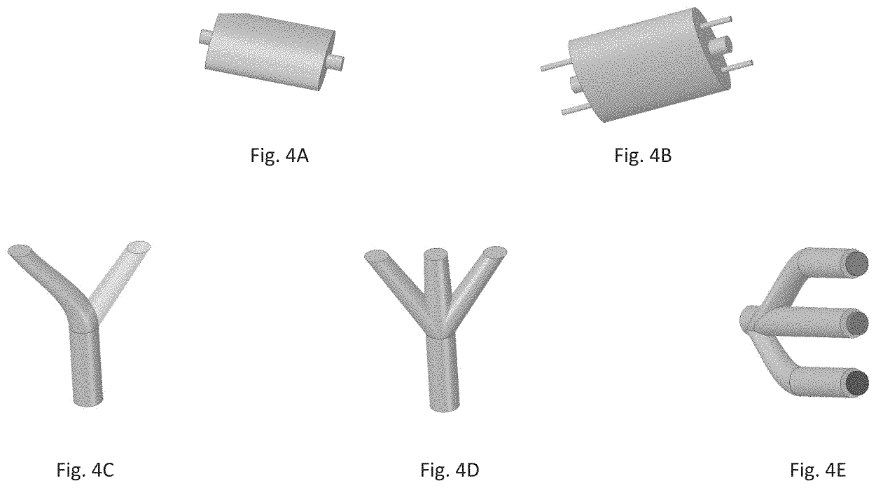

FIGS. 4A-4E provide other examples of waveguides in accordance with embodiments of the present invention; for example, FIG. 4A shows a single channel waveguide surrounded by a support medium, and FIG. 4B shows a three-channel waveguide surrounded by a support medium with each channel having a different diameter. Each of the waveguides in FIGS. 4A-4B are substantially linear through the support medium; however, it should be appreciated that the waveguides need not be linear and can include angles, curves, branches, and other nonlinear modifications, such as the waveguides shown in FIGS. 4C-4E. Specifically, FIG. 4C shows a bifurcated waveguide with each branch having different optical properties (i.e., the right guide being more transparent than the left guide), and FIG. 4D shows a trifurcated waveguide with approximately equal optical properties for each guide branch. FIG. 4E shows that the internal optical properties can differ between one or more of the waveguide branches, showing that a red color effect, a green color effect, and a blue color effect can act on light in different branches.

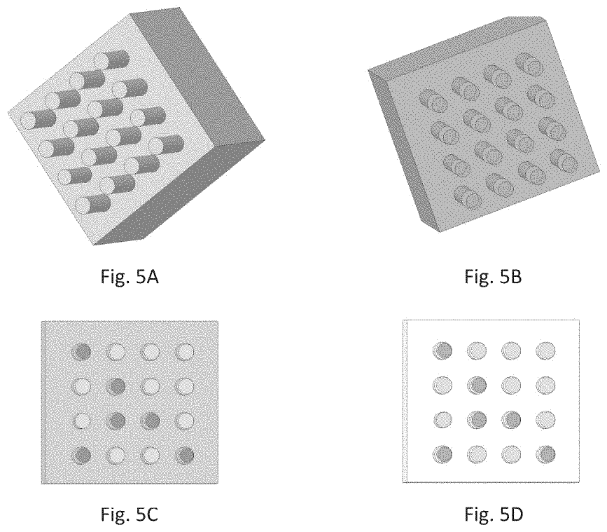

FIGS. 5A-5D show examples of the application of the waveguides described above in an array, such as a location array in which sensing waveguides are used to sense touch, pressure, or other mechanical interactions. These sensations are detected by their effects on the throughput of light through the array and the various waveguides within the array. Specifically, interaction with one or more waveguides within the array via touch or pressure reduces the amount of light visible within the array, allowing for tactile implementations of the waveguide(s) and/or array by way of position tracking and force sensing. In addition, altering the state of total internal reflection within the waveguide can alter the touch sensing tactile implementation of the waveguides described herein. Total internal reflection allows the waveguide to propagate light without loss. As such, a waveguide system can be arranged such that light is conducted through the waveguide and sheath interface when a discreet point of the guide receives pressure or other mechanical communication. Such a contact causes a break in the total internal reflection, thereby allowing light to leak out of the guided path, changing the throughput of the waveguide.

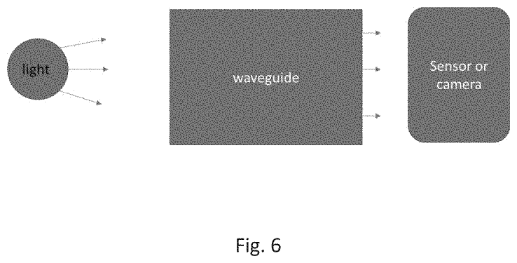

It should be appreciated that each waveguide branch, or element, can include a single color, multiple colors, or an absence of color, such that each waveguide can act independently and can be tailored to a specific application. LED lights and LED arrays can be used. A single photodetector or array detector can be used to determine the amplitude throughput and the color of each element. Single element photodiodes can be used as well as multielement detector arrays. Moreover, as shown in FIG. 6, a sensing component, such as a sensor or a camera, can be disposed adjacent to the waveguide to capture the throughput of the system.

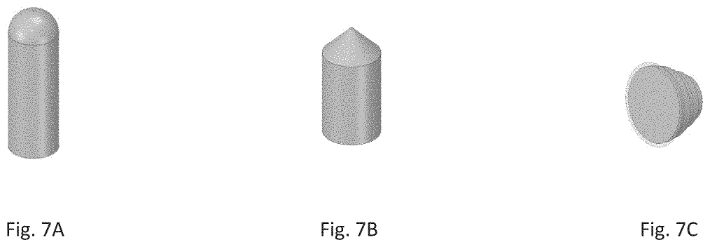

As shown in FIGS. 7A-7C, embodiments of the present invention include waveguide focusing apparatuses that act to focus light through one or more discreet points within the waveguide. For example, a focusing apparatus can be disposed at the entrance of the waveguide to cause increased light gathering and propagation within the waveguide. A focusing apparatus can also be disposed at the exit of the waveguide, such as between the waveguide and a sensing component, to focus the light leaving the waveguide into the sensing component. In addition, FIG. 7C depicts a specially-shaped focusing apparatus that operates similar to a lens by including multiple concentric sheaths of variable refractive indexes, such that the light exiting the waveguide can be focused similar to the focusing of a lens.

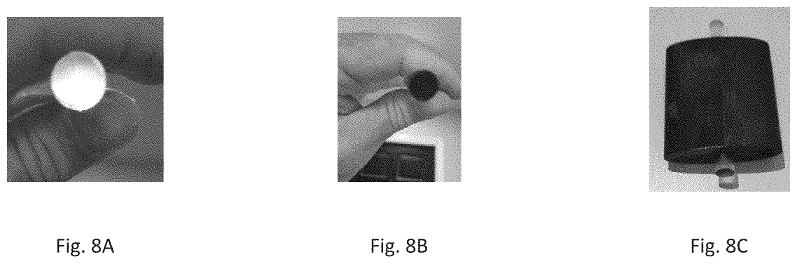

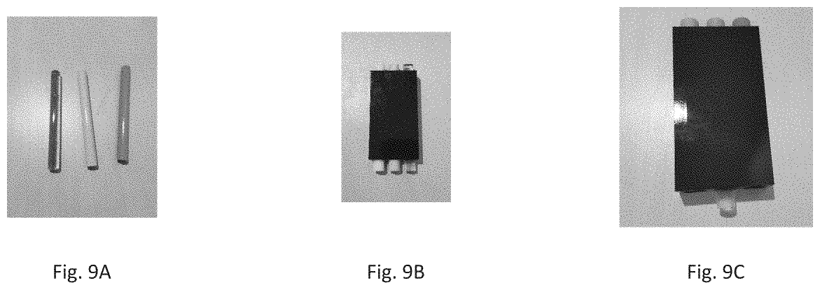

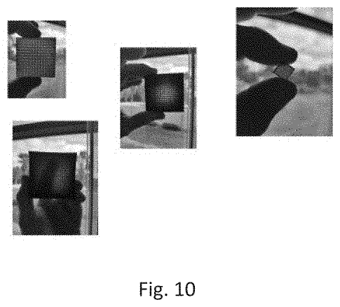

Examples of a single-element additive manufactured waveguide are shown in FIGS. 8A-8C, including light throughput shown in FIG. 8A, light obstruction shown in FIG. 8B, and the waveguide disposed within a support material in FIG. 8C. In addition, FIGS. 9A-9C show various transparent and colored waveguides that can be used alone or in combination with each other, each having different optical properties (although it should be appreciated that the waveguides can have uniform optical properties in alternative embodiments). FIG. 9B in particular shows the waveguides of FIG. 9A disposed within a support material. FIG. 9C shows a waveguide including a single transparent input that is trifurcated to a multicolor output using a structure similar to that shown in FIG. 4D. In addition, FIG. 10 shows various examples of additive manufactured optical waveguides manufactured in accordance with embodiments of the present invention disclosed herein.

As FIGS. 3-10 depict various waveguides and tactile devices including waveguides that are additive manufactured for sensing application, the particular sensations interactable by a user are customizable on a voxel-by-voxel level within the device prior to the additive manufacturing process, as discussed in detail above. To that end, highly tunable anisotropic optical properties are experienced within the final manufactured devices, such that the devices are usable for a variety of tactile purposes depending on the requirements of the manufacturing process. These anisotropic optical properties include attenuation, polarization, signal phase change, and other optical properties are noted in the sections above. Since the optical properties are tunable on a voxel-by-voxel level, adjacent portions of the printed object can exhibit different optical properties, leading to highly customizable tactile devices for user interaction. These optical properties are determined by the shape, structure, and base materials of the optical waveguides designed and manufactured in accordance with the present invention.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention that, as a matter of language, might be said to fall therebetween.

What is claimed is:

1. An additive manufactured optical waveguide assembly including an optical waveguide disposed within a tactile additive manufactured object, the additive manufactured optical waveguide assembly comprising:
an optical waveguide made of a transparent material having a first refractive index, the optical waveguide having a first end opposite a second end, such that the optical waveguide is configured to direct light from the first end to the second end;
a sheath surrounding the optical waveguide, the sheath having a second refractive index that differs from the first refractive index, such that the optical waveguide is configured to experience total internal reflection of the light, and such that the optical waveguide is configured to prevent the light from escaping into the sheath;
a support medium secured to the sheath, the support medium configured to maintain a structure of the sheath during an additive manufacturing process; and
an additive manufactured object having a predetermined shape and size, the additive manufactured object surrounding the sheath, such that the optical waveguide and the sheath are disposed within the additive manufactured object within the optical waveguide assembly.

2. The additive manufactured optical waveguide assembly of claim 1, wherein the optical waveguide exhibits anisotropic optical properties.

3. The additive manufactured optical waveguide assembly of claim 2, wherein the anisotropic optical properties are selected from the group consisting of opaqueness, reflectiveness, colorization, transparency, transmission, absorption, refractive indices, attenuation, phase change, polarization, and stress birefringence.

4. The additive manufactured optical waveguide assembly of claim 1, wherein the optical waveguide includes a plurality of discreet points that correspond with a plurality of voxels of a virtual representation of the optical waveguide.

5. The additive manufactured optical waveguide assembly of claim 4, wherein each of the plurality of discreet points includes a customizable base material, such that optical properties of the optical waveguide are tunable for each of the plurality of discreet points.

6. The additive manufactured optical waveguide assembly of claim 4, further comprising a plurality of boundary layers disposed between adjacent discreet points of the plurality of discreet points.

7. The additive manufactured optical waveguide assembly of claim 6, wherein each of the plurality of boundary layers is discreet and wavelength-dependent.

8. The additive manufactured optical waveguide assembly of claim 1, wherein the optical waveguide is a single-channel waveguide configured to direct light from the first end to the second end.

9. The additive manufactured optical waveguide assembly of claim 1, wherein the optical waveguide includes a plurality of channels, the optical waveguide configured to direct light from the first end to the second end through each of the plurality of channels.

10. The additive manufactured optical waveguide assembly of claim 9, wherein at least one of the plurality of channels of the optical waveguide includes a volume that differs from a volume of the remaining plurality of channels.

11. The additive manufactured optical waveguide assembly of claim 1, wherein the optical waveguide is flexible and non-linear, such that the optical waveguide is configured to direct light from the first end to the second end in a non-linear path.

12. A method of designing and manufacturing integrated optical components in an additive manufactured composite structure for the purpose of physical sensing of forces applied to the structure, the method comprising the steps of:
designing a virtual model of the additive manufactured composite structure, the virtual model comprised of a plurality of voxels, the additive manufactured composite structure having a desired set of anisotropic optical properties, with each of the plurality of voxels being individually tunable by varying one or more optical properties;
manufacturing an additive manufactured composite structure based on the virtual model, the additive manufactured composite structure including:
an optical waveguide having a first refractive index, the optical waveguide having a first end opposite a second end, such that the optical waveguide is configured to direct light from the first end to the second end;
a sheath surrounding the optical waveguide, the sheath having a second refractive index that differs from the first refractive index, such that the optical waveguide is configured to experience total internal reflection of the light, and such that the optical waveguide is configured to prevent the light from escaping into the sheath; and
a support medium secured to the sheath, the support medium configured to maintain a structure of the sheath during an additive manufacturing process; and
directing light through the optical waveguide of the additive manufactured composite structure, such that physical sensing of forces applied to the structure can be accomplished by interacting with the light directed through the optical waveguide.

13. The method of claim 12, further comprising a plurality of boundary layers separating one or more of the plurality of voxels, wherein optical properties within the object differ as light passes through the plurality of boundary layers.

14. The method of claim 13, wherein each of the plurality of boundary layers is discreet and wavelength-dependent.

15. The method of claim 12, wherein the anisotropic optical properties are selected from the group consisting of opaqueness, reflectiveness, colorization, transparency, transmission, absorption, refractive indices, attenuation, phase change, polarization, and stress birefringence.

16. The method of claim 12, wherein the optical waveguide includes a plurality of discreet points that correspond with a plurality of voxels of a virtual representation of the optical waveguide.

17. The method of claim 12, wherein the optical waveguide is a single-channel waveguide configured to direct light from the first end to the second end.

18. The method of claim 12, wherein the optical waveguide includes a plurality of channels, wherein the step of directing light through the optical waveguide includes directing light through each of the plurality of channels.

19. The method of claim 18, wherein at least one of the plurality of channels of the optical waveguide includes a volume that differs from a volume of the remaining plurality of channels, wherein the step of directing light through the optical waveguide includes directing a different amount of light through at least one of the plurality of channels as compared with the remaining plurality of channels.

20. The method of claim 12, wherein the optical waveguide is flexible and non-linear, wherein the step of directing light through the optical waveguide includes directing light from the first end to the second end in a non-linear path.
